(19) United States
(12) Patent Application Publication
(10) Pub. No.: US 2007/0078770 A1
(43) Pub. Date: Apr. 5, 2007

(54) Storage device having a usage history display and a usage history displaying method thereof

(76) Inventor: Hsiang-An Hsieh, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/340,649

(22) Filed: Jan. 27, 2006

(30) Foreign Application Priority Data
Oct. 4, 2005 (TW) 94134658

(51) Int. Cl. G06Q 99/00

(52) U.S. Cl. 705/51

(57) ABSTRACT

A storage device having a usage history display includes a control unit. The control unit has a security information analysis module. The security information analysis module is used for processing security information of the usage history. A display unit is connected with the control unit and is used for displaying the security information of the usage history. A storage medium includes a security information storage area and the security information of the usage history is recorded in the security information storage area. Furthermore, the storage device having a usage history display includes a system interface connected with the control unit. The system interface is linked with a host application system. Thereby, the security information analysis module reads the security information of the usage history in the security information storage area and displays the security information of the usage history on the display unit.

### BACKGROUND OF THE INVENTION

1. Field of the Invention

The present invention relates to security information of a storage device. In particular, this invention relates to a storage device having a usage history display and a usage history displaying method thereof.

2. Description of the Related Art

Because the demand of information exchange has grown so rapidly, from the floppy disk to the portable hard disk and the non-volatile memory card, the capacity of storage devices has become larger while their size has become smaller. Although the capacity of the storage device satisfies the demands of information exchange, security has become an urgent issue.

Some storage devices protect information in the storage devices. For example, some storage devices require users to enter a password or verify themselves via fingerprint identification. After the user has been authorized, then the user can read/write or access the information in the storage device. If the user is not authorized, the user is forbidden to access the protected information.

However, the above method is unreliable in that it doesn't let users know whether their protected information has been accessed or not. In other words, the user has no way of knowing if protection methods have been compromised and whether or not their protected information in the storage device has been accessed.

### SUMMARY OF THE INVENTION

The present invention displays an accumulated login number, an accumulated time of usage, a previous login date and time and/or a previous logout date and time on the display unit of the storage device. After the user login to and logout of the storage device, the security information, such as described above, is recorded and indicated. Therefore, the user can check whether the information displayed on the display unit matches the usage history or not. If the displayed information does not match the usage history of the user, it means the information in the storage device has probably been compromised or exposed to unauthorized usage. Therefore, the user needs to take an appropriate course of action.

The present invention provides a storage device having a usage history display. The storage device having a usage history display includes a control unit. The control unit has a security information analysis module. The security information analysis module is used for processing security information of the usage history. The storage device having a usage history display also includes a display unit electrically connected with the control unit. The information of the usage history is displayed on the display module. The storage device having a usage history display also includes a storage medium. The storage medium includes a security information storage area. The security information of the usage history is recorded in the security information storage area. Furthermore, the storage device having a usage history display includes a system interface electrically connected with the control unit. The system interface is linked with a host application system. Thereby, when the storage device is linked with the host application system, the security information analysis module processes the security information of the usage history, stores the security information of the usage history in the security information storage area and displays the security information of the usage history on the display unit.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a block diagram of a first embodiment of the present invention;

FIG. 2 is a flow chart of a first embodiment of the present invention;

FIG. 3 is a block diagram of a second embodiment of the present invention;

FIG. 4 is a flow chart of a second embodiment of the present invention;

FIG. 5 is a block diagram of a third embodiment of the present invention;

FIG. 6 is a flow chart of a third embodiment of the present invention;

FIG. 7 is a block diagram of a fourth embodiment of the present invention; and

FIG. 8 is a flow chart of a fourth embodiment of the present invention.

### DETAILED DESCRIPTION OF THE PREFERRED EMBODIMENTS

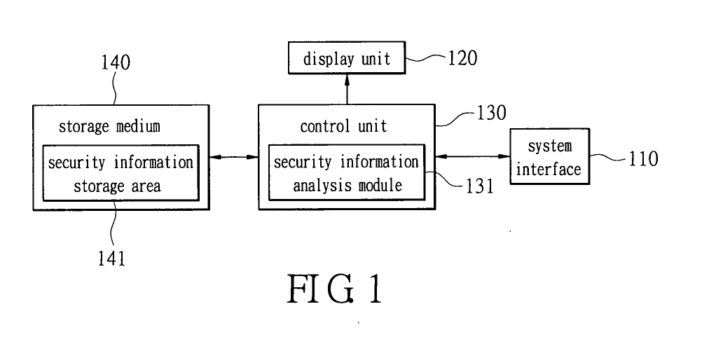

Please refer to FIG. 1, which shows a block diagram of a first embodiment of the present invention. In FIG. 1, the system interface 110 is used for linking with an external application system. The system interface 110 can be linked with a computer system or a read/write or accessing device of the storage device. The system interface 110 is also connected with a control unit 130. The control unit 130 has a security information analysis module 131. The security information analysis module 131 is used for verifying the user, processing the information and generating security information of the usage history. A display unit 120 is also connected with the control unit 130. The display unit 120 is used for displaying the security information of the usage history. A storage medium 140 is used for storing digital information. The storage medium 140 includes a security information storage area 141. The security information storage area 141 is used for storing the security information processed by the security information analysis module 131. The display unit 120 can be a bi-state display device or the storage device further includes an independent power source (not shown in the figure) for providing the power to the display unit 120. Therefore, the security information can be displayed at any time. Furthermore, the storage device can be a portable storage device.

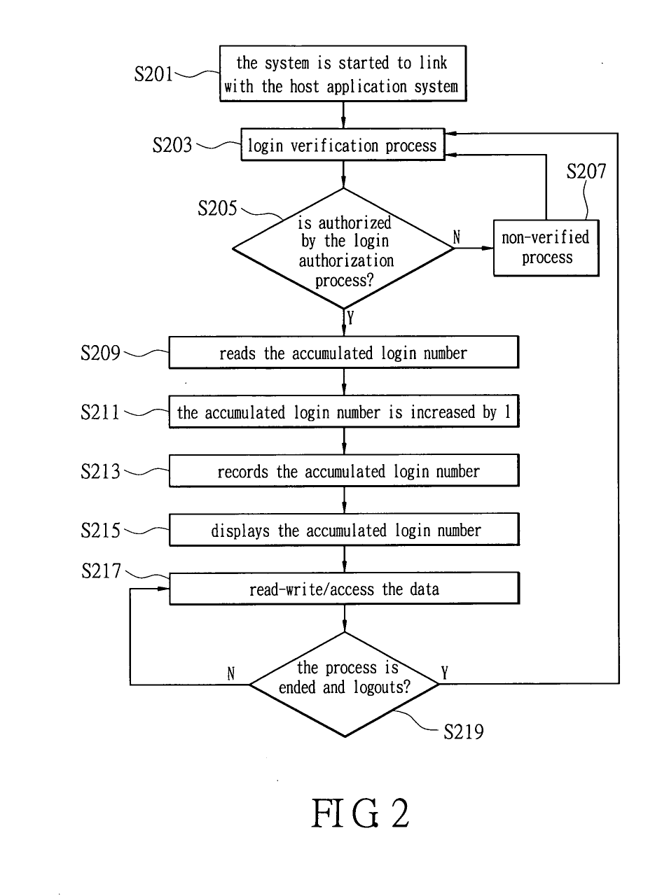

Please refer to FIGS. 1 and 2. FIG. 2 shows a flow chart of a first embodiment of the present invention. Firstly, the system interface 110 is started to link the storage device with a host application system (Step S201 as shown in FIG. 2). A login authorization process is executed (Step S203). Only after the user has been authorized by the login authorization process, the user can read/write or access the information in the security information storage area 141 via the security information analysis module 131. The method determines whether the user has been authorized by the login authorization process or not (Step S205). If the user has been authorized via the login authorization process, a next step is executed. If the user has not been authorized via the login authorization process, a non-verified process is executed. Reading/writing or accessing information in the security information storage area 141 is forbidden and the login authorization process is repeated (Step S207). After the user has been authorized, the security information analysis module 131 reads the accumulated login number stored in the security information storage area 141 (Step S209). The accumulated login number read in step S209 is increased with one (Step S211). Then, the accumulated login number is recorded in the security information storage area 141 (Step S213). The accumulated login number, the previous accumulated login number, or both, is displayed on the display unit 20 (Step S215). Therefore, the user can manage the security information. Then, the read/write or access process executed at the storage medium 140 or the security information storage area 141 is allowed (Step S217). Finally, whether the process has ended or the user has logged out is determined (Step 219). If the process is not ended or the user has not logged out yet, step S217 is continuously executed. If the process is ended or the user has logged out, step S203 is executed. The accumulated login number cannot be reset to zero.

By the above accumulated login number, the user can manage the login number executed to make sure whether the information in the security information storage area 141 has been read/written or accessed by others. For example, the login number is 1234 and is displayed on the display unit 120. If the last login number is 1234 for the user, it means the storage device has not been accessed by others. If the last login number for a user is 1233 for example, it means the storage device has been accessed by others.

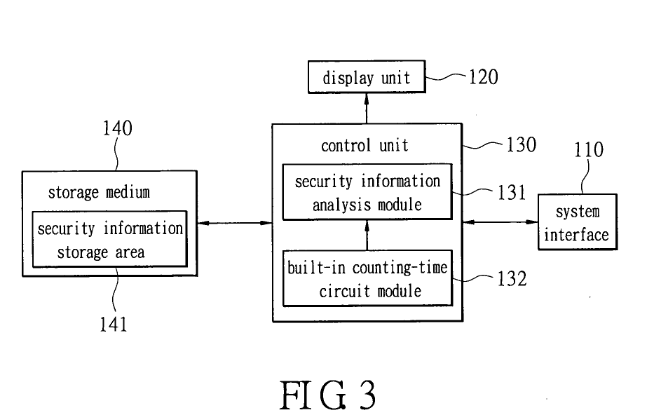

Please refer to FIG. 3, which shows a block diagram of a second embodiment of the present invention. In FIG. 3, the system interface 110 is used for linking with an external application system. The system interface 110 can be linked with a computer system or a read/write or accessing device of the storage device. The system interface 110 is also connected with a control unit 130. The control unit 130 has a security information analysis module 131 and a built-in counting-time circuit module 132. The security information analysis module 131 is used for verifying the user, processing the information and generating security information of the usage history. The built-in counting-time circuit module 132 is used for counting the usage time of the storage device. Its function is the same as the function of accumulating calling time in a cell phone. A display unit 120 is also connected with the control unit 130. The display unit 120 is used for displaying the security information of the usage history. A storage medium 140 is used for storing digital information. The storage medium 140 includes a security information storage area 141. The security information storage area 141 is used for storing security information processed by the security information analysis module 131. The display unit 120 can be a bi-state display device or a storage device further including an independent power source (not shown in the figure) for providing power to the display unit 120. Therefore, security information can be displayed at any time. Furthermore, the storage device can be a portable storage device.

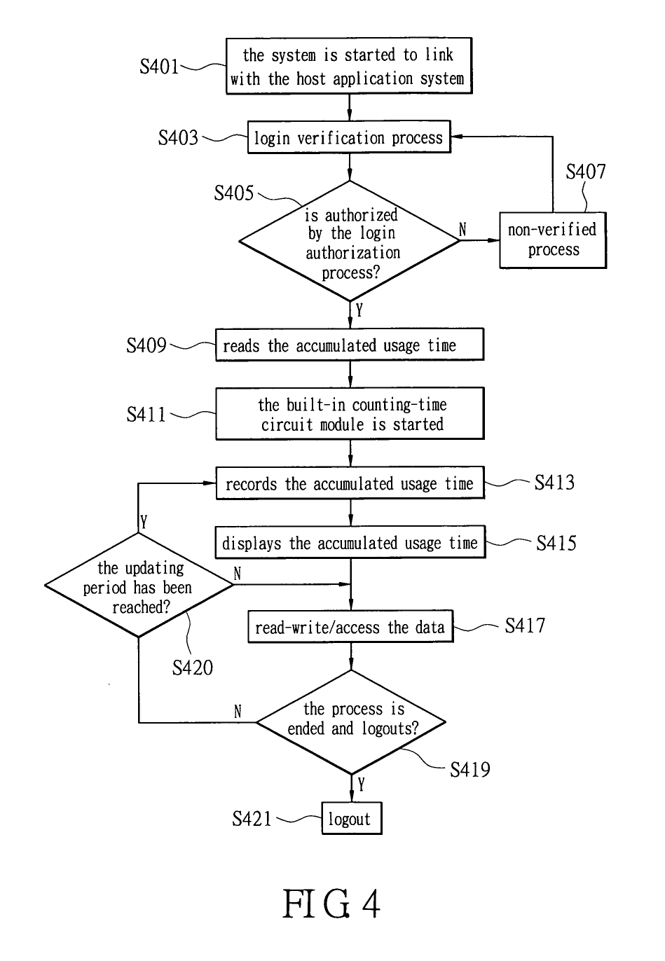

Please refer to FIGS. 3 and 4. FIG. 4 shows a flow chart of a second embodiment of the present invention. Firstly, the system interface 110 is started to link the storage device with a host application system (Step S401 as shown in FIG. 4). A login authorization process is executed and the built-in counting-time circuit module 132 is started to count the usage time (Step S403). Only after the user has been authorized via the login authorization process, the user can read/write or access the information in the security information storage area 141 via the security information analysis module 131. The method determines whether the user has been authorized by the login authorization process or not (Step S405). If the user has been authorized via the login authorization process, a next step is executed. If the user has not been authorized via the login authorization process, a non-verified process is executed. The read/write or access of the information of the security information storage area 141 is forbidden and the login authorization process is repeated (Step S407). After the user has been authorized, the security information analysis module 131 reads the accumulated usage time stored in the security information storage area 141 (Step S409). Then, the built-in counting-time circuit module 132 is started to count the usage time for this login. The counted usage time is added to the previous accumulated usage time read at step S409 and the usage time is continuously accumulated (Step S411). Then, the security information analysis module 131 stores the accumulated usage time in the security information storage area 141 for each updating period (Step S413). The accumulated usage time is displayed on the display unit 20 (Step S415). Then, the read/write or access process executed at the storage device 140 or the security information storage area 141 is allowed (Step S417). Finally, the process ending or logout is determined (Step 419). If the process is not ended or the user has not logged out yet, reaching the updating period is determined (Step S420). If the updating period has been reached, step S413 is repeated to record the accumulated usage time. If the updating period is not reached, step S417 is repeated to read/write or access the storage device. If the process is ended or the user has logged out, the logout process is executed (Step S421). After the user logs out, the accumulated usage time stored in the security information storage area 141 is the last accumulated usage time stored in the security information storage area 141. The accumulated usage time displayed on the display unit 120 is the last accumulated usage time displayed on the display unit 120. The accumulated usage time cannot be reset to zero.

By the above accumulated usage time, the user can manage the usage time used to make sure whether the information in the security information storage area 141 has been read/written or accessed by others. For example, if the accumulated usage time is 1 hour 23 minutes and 45 seconds at the last logout and if the display unit 120 shows an accumulated usage time is 1 hour 26 minutes and 45 seconds, it means the storage device has been accessed for 3 minutes by others.

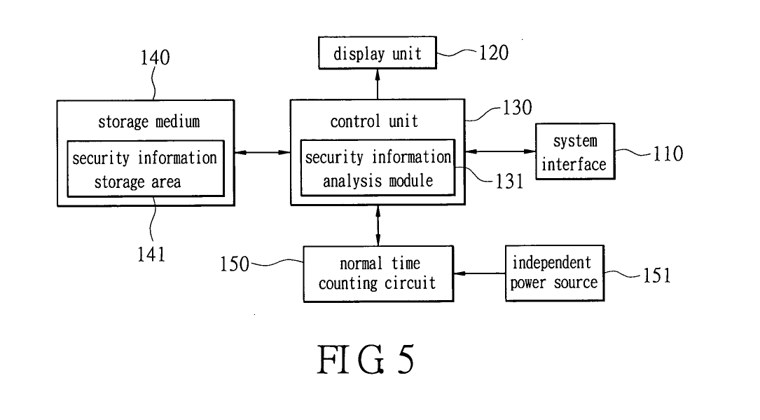

Please refer to FIG. 5, which shows a block diagram of a third embodiment of the present invention. In FIG. 5, the system interface 110 is used for linking with an external application system. The system interface 110 can be linked with a computer system or a read/write or accessing device of the storage device. The system interface 110 is also connected with a control unit 130. The control unit 130 has a security information analysis module 131. The security information analysis module 131 is used for verifying the user, processing the information and generating security information of the usage history. A display unit 120 is also connected with the control unit 130. The display unit 120 is used for displaying the security information. A storage medium 140 is used for storing digital information. The storage medium 140 includes a security information storage area 141. The security information storage area 141 is used for storing the security information processed by the security information analysis module 131. A normal time counting circuit 150 is used for counting the standard time (the routine date and time). The power is provided by an independent power source to maintain the counting of the standard time. The display unit 120 can be a bi-state display device or the storage device can further include an independent power source (not shown in the figure) for providing power to the display unit 120. Therefore, the security information can be displayed at any time. Furthermore, the storage device can be a portable storage device.

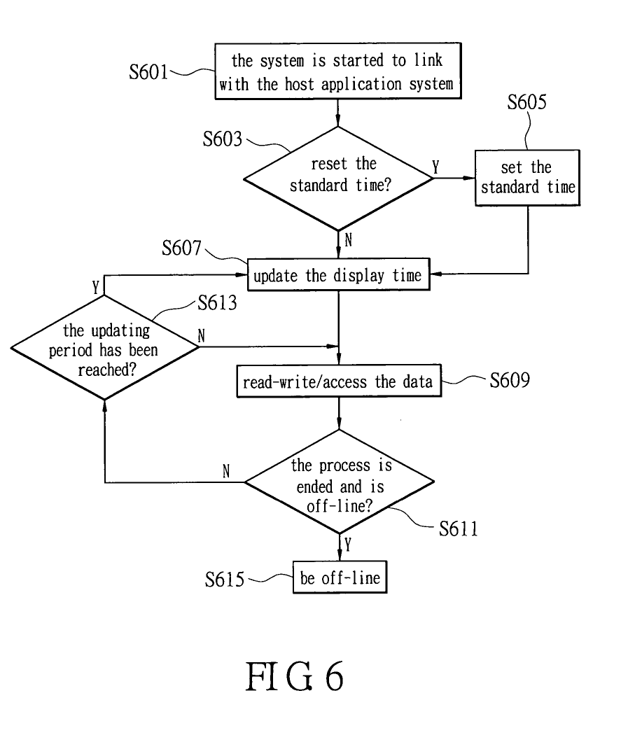

Please refer to FIGS. 5 and 6. FIG. 6 shows a flow chart of a third embodiment of the present invention. Firstly, the system interface 110 is started to link the storage device with a host application system (Step S601 as shown in FIG. 6). The security information analysis module 131 executes a time collating program, or the host application system executes an application. The standard time of the normal time counting circuit 150 is collated according to the system time of the host application system or Internet standard time for determining whether the standard time of the normal time counting circuit 150 needs to be reset or not (Step S603). If the standard time of the normal time counting circuit 150 needs to be reset, the standard time of the normal time counting circuit 150 is updated by the system time of the host application system or the Internet standard time (Step S605). If the standard time of the normal time counting circuit 150 does not need to be reset or the standard time of the normal time counting circuit 150 has been updated, the security information analysis module 131 reads the standard time from the normal time counting circuit 150 and displays the standard time on the display unit 120 for each updating period (Step S607). Then, the read/write or access process is allowed (Step S609). Finally, the processing ending or logout is determined (Step 611). If the user has not logged out yet, whether or not the updating period has been reached is determined (Step S613). If the updating period has not been reached, the method returns to step S609. If the updating period has been reached, step S607 is repeated to read the standard time from the normal time counting circuit 150 and the standard time is displayed on the display unit 120 for each updating period record via the security information analysis module 131. At step S611, if the processing ending is ended or the user has logged out, an off-line process is executed (Step S615). Next, the normal time counting circuit 150 records the last updated standard time and the display unit 120 displays the last updated standard time. The above-described standard time is a routine date and time.

By using the above-described method of displaying the logout date and time obtained by the storage device, the user can manage the logout date and time that the storage device displays to know whether or not the information in the storage device has been read/written or accessed by others. For example, if the last time the user logged out from the storage device was 2005/1/1 22:33:44, and if the user returns to their device to find the logout time displayed on the display unit 120 is 2005/1/2 3:44:55, they will be able to see that the displayed logout time is different from the previous one, meaning that the storage device has been accessed by others.

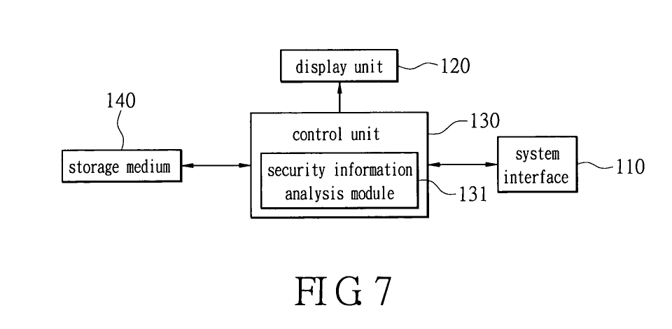

Please refer to FIG. 7, which shows a block diagram of a fourth embodiment of the present invention. In FIG. 7, the system interface 110 is used for linking with an external application system. The system interface 110 can be linked with a computer system or a read/write or accessing device of the storage device. The system interface 110 is also connected with a control unit 130. The control unit 130 has a security information analysis module 131. The security information analysis module 131 is used for processing the information and generating security information of the usage history. A display unit 120 is also connected with the control unit 130. The display unit 120 is used for displaying the security information. A storage medium 140 is used for storing digital information. The display unit 120 can be a bi-state display device or the storage device can further include an independent power source (not shown in the figure) for providing power to the display unit 120. Therefore, security information can be displayed at any time. Furthermore, the storage device can be a portable storage device.

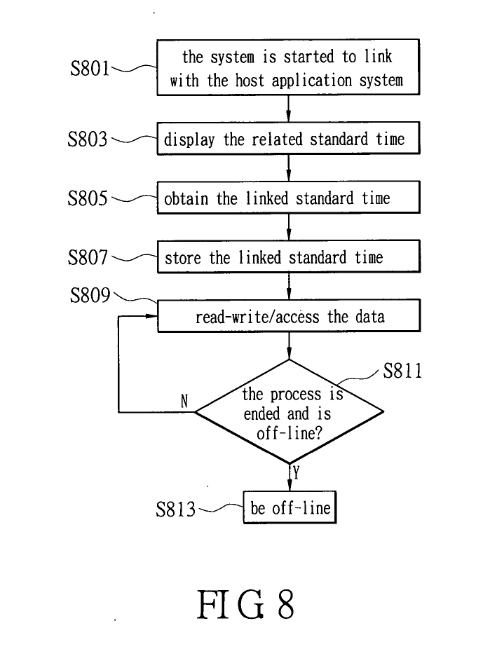

Please refer to FIGS. 7 and 8. FIG. 8 shows a flow chart of a fourth embodiment of the present invention. Firstly, the system interface 110 is started to link the storage device with a host application system (Step S801 as shown in FIG. 8). The display unit 120 displays the standard time stored in the storage medium 140. The standard time stored in the storage medium 140 is the last login time (Step S803). The host application system executes an application program or the security information analysis module 131 executes a time obtaining program via the host application system to obtain a standard time for the Internet (Step S805). The security information analysis module 131 stores the standard time for the login in the of the storage medium 140 (Step S807). Then, the read/write or access process executed at the storage medium 140 is allowed (Step S809). Finally, whether the process is ended or if the user has logged out is determined (Step 811). If the processing has not ended or the user has not logged out, step S809 is repeated. If the processing ending has ended or the user has logged out, an off-line process is executed (Step S813). The above-described standard time is a routine date and time.

By using the above-described method of displaying the login date and time, the user can manage the login date and time that the storage device displays to know whether or not the information in the storage device has been read/written or accessed by others. For example, the last time the user logs in to the storage device is at 2005/1/1 22:33:44. If the user returns to find the login time displayed on the display unit 120 is 2005/1/2 3:44:55, it means the storage device has been login by others at 2005/1/2 3:44:55.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A storage device having a usage history display, comprising:
a control unit having a security information analysis module; wherein the security information analysis module is used for processing security information of the usage history;
a display unit electrically connected with the control unit; wherein the security information of the usage history is displayed on the display module;
a storage medium including a security information storage area; wherein the security information of the usage history is recorded in the security information storage area and
a system interface electrically connected with the control unit; wherein the system interface is linked with a host application system for executing the information transmission.

2. The storage device having a usage history display as claimed in claim 1, wherein the usage history security information is a standard time when the storage device is on-line, a standard time when the storage device is off-line, an accumulated usage time of the storage device and/or a accumulated number of times of power cycle, on-line cycle or login of the storage device.

3. The storage device having a usage history display as claimed in claim 1, further comprising:
a normal time counting circuit electrically connected with the control unit, for counting a standard time;
an independent power, for providing power to the normal time counting circuit.

4. The storage device having a usage history display as claimed in claim 3, wherein the security information analysis module obtains the standard time from the normal time counting circuit, stores the standard time in the security information storage area, and displays the standard time on the display unit.

5. The storage device having a usage history display as claimed in claim 3, wherein the security information analysis module reads the standard time from the normal time counting circuit according a predetermined read period, and stores the standard time in the security information storage area and displays the standard time on the display unit.

6. The storage device having a usage history display as claimed in claim 3, wherein the security information analysis module reads a previous logout time of the storage device from the security information storage area when the storage device is started, and displays the standard time on the display unit.

7. The storage device having a usage history display as claimed in claim 1, wherein the host application system executes an application program or the security information analysis module executes a time obtaining program to obtain a standard time from the Internet when the storage device is linked with the host application system, and stores the standard time in the security information storage area and displays the standard time on the display unit.

8. The storage device having a usage history display as claimed in claim 1, wherein the host application system executes-an application program or the security information analysis module executes a time obtaining program to obtain a standard time from the Internet before the storage device is logged out from the host application system, and stores the standard time in the security information storage area and displays the standard time on the display unit.

9. The storage device having a usage history display as claimed in claim 1, wherein the control unit further comprises a built-in counting-time circuit module; wherein the built-in counting-time circuit module is used for counting the usage time of the storage device.

10. The storage device having a usage history display as claimed in claim 1, wherein the security information analysis module obtains an accumulated usage time from the security information storage area and obtains a current usage time of the storage device from the built-in counting-time circuit module and the accumulated usage time is added with the current usage time, and the accumulated usage time is stored in the security information storage area and the accumulated usage time is displayed on the display unit.

11. The storage device having a usage history display as claimed in claim 1, wherein the security information analysis module accumulates the login number of the storage device, and stores the accumulated login number in the security information storage area and displays the accumulated login number on the display unit.

12. The storage device having a usage history display as claimed in claim 1, wherein the display unit is a bi-state display device.

13. The storage device having a usage history display as claimed in claim 1, further comprising an independent power source for providing power to the display unit; thereby, the security information is displayed at any time.

14. The storage device having a usage history display as claimed in claim 1, wherein the host application system is a computer system or a read-write/access device of the portable device.

15. The storage device having a usage history display as claimed in claim 1, wherein the storage device is a portable storage device.

16. A method for displaying the usage history of the storage device, the steps comprising:
linking with a host application system and executing a login authorization process;
reading a first security information via a security information analysis module after the user has been authorized by the login authorization process;
updating the first security information to a second security information;
recording the second security information; and
displaying the second security information on a display unit.

17. The method for displaying the usage history of the storage device as claimed in claim 16, wherein the security information analysis module is located in a control unit of the storage device.

18. The method for displaying the usage history of the storage device as claimed in claim 16, wherein the security information analysis module reads the first security information from a security information storage area.

19. The method for displaying the usage history of the storage device as claimed in claim 16, wherein the first security information is an accumulated login number and the accumulated login number is calculated by adding together the number of times that the storage device has been logged into previously.

20. The method for displaying the usage history of the storage device as claimed in claim 19, wherein the accumulated login number is increased by 1 for updating the first security information.

21. The method for displaying the usage history of the storage device as claimed in claim 16, wherein the security information analysis module records the second security information in a security information storage area.

22. The method for displaying the usage history of the storage device as claimed in claim 16, wherein the first security information is an accumulated usage time and the accumulated usage time is calculated by adding together an accumulated time that the storage device has been used for previously.

23. The method for displaying the usage history of the storage device as claimed in claim 22, wherein after the user has been authorized by the login authorization process, a built-in counting-time circuit module continuously accumulates the time according the previous accumulated usage time and updates the first security information to the second security information.

24. The method for displaying the usage history of the storage device as claimed in claim 23, wherein the security information analysis module records the second security information according to a updating period.

25. The method for displaying the usage history of the storage device as claimed in claim 16, wherein the display unit is a bi-state display device for continuously displaying the second security information on the storage device.

26. The method for displaying the usage history of the storage device as claimed in claim 16, wherein the storage device is a portable storage device.

27. A method for displaying the usage history of the storage device, by linking with a host application system to process the usage history security information of the storage device, the steps comprising:
determining whether a standard time counted by a normal time counting circuit needs to be reset or not;
setting the standard time of the normal time counting circuit, if the standard time counted needs to be reset;
reading the standard time and displaying the standard time on a display unit via a security information analysis module; and
reading the standard time, and updating and displaying the standard time on a display unit via a security information analysis module.

28. The method for displaying the usage history of the storage device as claimed in claim 27, wherein the normal time counting circuit is provided power by an independent power source for continuously counting the standard time.

29. The method for displaying the usage history of the storage device as claimed in claim 27, wherein the security information analysis module reads the standard time according to a updating period.

30. The method for displaying the usage history of the storage device as claimed in claim 27, wherein the host application system executes an application program that is based on the system time of the application or the Internet standard time to set the counting time of the normal time counting circuit.

31. The method for displaying the usage history of the storage device as claimed in claim 27, wherein the security information analysis module of the storage device executes a time obtaining program that is based on the system time of the application or the Internet standard time to set the counting time of the normal time counting circuit.

32. The method for displaying the usage history of the storage device as claimed in claim 27, wherein the security information analysis module reads the standard time from the normal time counting circuit.

33. The method for displaying the usage history of the storage device as claimed in claim 27, wherein the display unit displays the last updated standard time.

34. The method for displaying the usage history of the storage device as claimed in claim 27, wherein the display unit is a bi-state display device for continuously displaying the second security information on the storage device.

35. The method for displaying the usage history of the storage device as claimed in claim 27, wherein the storage device is a portable storage device.

36. A method for displaying the usage history of the storage device, by linking with a host application system that is linked to the Internet to process the usage history security information of the storage device, the steps comprising:
linking with the host application system;
obtaining a linking standard time from the Internet, after the storage device is linked;
storing the linking standard time in a storage medium of the storage device; and
displaying the linking standard time on a display unit.

37. The method for displaying the usage history of the storage device as claimed in claim 36, wherein the host application system executes an application program to obtain the linking standard time from the Internet.

38. The method for displaying the usage history of the storage device as claimed in claim 36, wherein the security information analysis module of the storage device executes a time obtaining program to obtain the linking standard time from the Internet.

39. The method for displaying the usage history of the storage device as claimed in claim 36, wherein the linking standard time is displayed on the display unit when the storage device is started.

40. The method for displaying the usage history of the storage device as claimed in claim 36, wherein the display unit is a bi-state display device for continuously displaying the second security information on the storage device.

41. The method for displaying the usage history of the storage device as claimed in claim 36, wherein the storage device is a portable storage device.
